(19) United States
(12) Patent Application Publication
(10) Pub. No.: US 2019/0250001 A1
(43) Pub. Date: Aug. 15, 2019

(54) VEHICLE CONTROL SYSTEM, VEHICLE CONTROL METHOD, AND VEHICLE STORAGE MEDIUM

(71) Applicant: HONDA MOTOR CO., LTD., Minato-ku, Tokyo (JP)

(72) Inventors: Yusuke Nakamura, Wako-shi (JP); Yoshitaka Mimura, Wako-shi (JP)

(21) Appl. No.: 16/344,033

(22) PCT Filed: Nov. 8, 2016
(86) PCT No.: PCT/JP2016/083046

§ 371 Date: Apr. 23, 2019

(51) Int. Cl. G01C 21/34; G05D 1/00

(52) U.S. Cl. CPC G01C 21/3415; G05D 2201/0213; G05D 1/0061; G05D 1/0088

(57) ABSTRACT

A vehicle control system includes a searcher that searches for a route along which a vehicle is to travel to a destination, an automated driving controller that executes automated driving of causing the vehicle to automatically travel along the route found by the searcher, a receiving unit that receives an operation performed by an occupant of the vehicle, and a search controller that causes the searcher to recalculate the route on the basis of a predetermined condition when the occupant has performed an operation on the receiving unit to cause the vehicle to travel in a direction out of the route at a branch road.

### TECHNICAL FIELD

Embodiments of the present invention relate to a vehicle control system, a vehicle control method, and a storage medium.

### BACKGROUND ART

In recent years, research on a technology for automatically controlling at least one of acceleration/deceleration and steering of an own vehicle (hereinafter referred to as automated driving) has advanced. In this regard, a technology in which when automated driving is being executed in an automated driving zone included in a planned traveling route, automated driving is switched to manual driving at a branch road within the automated driving zone and then manual driving is switched to automated driving when the vehicle has passed through the branch road has been disclosed (see, for example, Patent Literature 1).

### CITATION LIST

### Patent Literature

### [Patent Literature 1]

Japanese Unexamined Patent Application, First Publication No. 2016-50901

### SUMMARY OF INVENTION

### Technical Problem

However, in the technology described in Patent Literature 1, when the occupant desires to change a planned travel route without changing the destination according to his or her intention, there is a possibility of the vehicle being unable to return from manual driving to automated driving if the vehicle is caused to travel deviating from the planned travel route.

The present invention has been made in view of such circumstances and it is an object of the present invention to provide a vehicle control system, a vehicle control method, and a vehicle control program wherein, when the traveling route of the vehicle deviates from a route, along which automated driving is being executed, due to the occupant's operation, it is possible to appropriately switch the route.

### Solution to Problem

(1): A vehicle control system including a searcher configured to search for a route along which a vehicle is to travel to a destination, an automated driving controller configured to execute automated driving of causing the vehicle to automatically travel along the route found by the searcher, a receiving unit configured to receive an operation performed by an occupant of the vehicle, and a search controller configured to cause the searcher to recalculate the route on the basis of a predetermined condition when the occupant has performed an operation on the receiving unit to cause the vehicle to travel in a direction out of the route at a branch road.

(2): The vehicle control system according to (1), wherein the receiving unit is configured to receive an operation indicating an instruction to automatically change a traveling lane of the vehicle.

(3): The vehicle control system according to (1), wherein the receiving unit is configured to receive an operation to change a steering angle of the vehicle.

(4): The vehicle control system according to (1), wherein the predetermined condition is that it is difficult to cause the vehicle to travel along the route found by the searcher.

(5): The vehicle control system according to (2), wherein the predetermined condition is that a distance between a position of the vehicle when the reception unit receives an operation indicating an instruction to automatically change the traveling lane of the vehicle and a position at which the vehicle enters the branch road is within a predetermined distance or a distance calculated on the basis of a speed of the vehicle.

(6): The vehicle control system according to (2), wherein the predetermined condition is that a period of time from when the reception unit receives an operation indicating an instruction to automatically change the traveling lane of the vehicle to when the vehicle enters the branch road is within a predetermined period of time or a period of time calculated on the basis of a speed of the vehicle.

(7): The vehicle control system according to (2), wherein the predetermined condition is that a distance between a position at which lane change of the vehicle according to the operation received by the reception unit is expected to be completed and a position at which the vehicle enters the branch road is within a predetermined distance or a distance calculated on the basis of a speed of the vehicle.

(8): The vehicle control system according to (2), wherein the predetermined condition is that a period of time from when lane change of the vehicle according to the operation received by the reception unit is expected to be completed to when the vehicle enters the branch road is within a predetermined period of time or a period of time calculated on the basis of a speed of the vehicle.

(9): The vehicle control system according to (1), further including a determiner configured to determine whether or not to shift the driving mode of the vehicle from an automated driving mode to a manual driving mode on the basis of the route recalculated by the searcher,

wherein the automated driving controller is configured to continue or terminate execution of the automated driving on the basis of a result of the determination of the determiner.

(10): The vehicle control system according to (9), further including a notifying unit configured to provide notification of shift to manual driving when the automated driving controller terminates execution of the automated driving.

(11): A vehicle control method using a computer including searching for a route along which a vehicle is to travel to a destination, executing automated driving of causing the vehicle to automatically travel along the found route, and recalculating the route on the basis of a predetermined condition when an occupant of the vehicle has performed an operation to cause the vehicle to travel in a direction out of the route at a branch road.

(12): A computer-readable non-transitory storage medium storing a vehicle control program causing a computer to search for a route along which a vehicle is to travel to a destination, execute automated driving of causing the vehicle to automatically travel along the found route, and recalculate the route on the basis of a predetermined condition when an occupant of the vehicle has performed an operation to cause the vehicle to travel in a direction out of the route at a branch road.

### Advantageous Effects of Invention

According to (1) to (3), (11), and (12) when the occupant of the vehicle has performed an operation to cause the vehicle to travel in a direction out of the route at a branch road, the route is recalculated on the basis of the predetermined condition. Therefore, when the traveling route of the vehicle deviates from a route, along which automated driving is being executed, with the intention of the occupant, it is possible to appropriately switch the route.

According to (4), the route is recalculated when it is difficult to cause the vehicle to travel along the found route. Therefore, it is possible to prevent lane change again to return to the found route after lane change is performed according to the occupant's intention.

According to (7), the route is recalculated when the distance between a position at which lane change of the vehicle according to the occupant's operation is expected to be completed and a position at which the vehicle enters the branch road is within the predetermined distance or a distance calculated on the basis of the speed of the vehicle. Therefore, it is possible to prevent lane change again to return to the found route when the distance from the position of the vehicle to a branch point is short.

According to (8), the route is recalculated when the period of time from when lane change of the vehicle according to the occupant's operation is expected to be completed to when the vehicle enters the branch road is within the predetermined period of time or the period of time calculated on the basis of the speed of the vehicle. Therefore, it is possible to prevent lane change again to return to the found route when the travel time from the position of the vehicle to a branch point is short.

According to (9), it is possible to determine whether or not to shift from the automated driving mode to the manual driving mode on the basis of the recalculated route and to continue or terminate execution of the automated driving on the basis of the determination result.

According to (10), when automated driving is terminated on the basis of the recalculated route, notification of the shift to the manual driving mode is provided. Therefore, when the vehicle deviates from the found route due to the occupant's operation, it is possible to shift from automated driving to manual driving while the occupant is made aware of the shift to manual driving.

### BRIEF DESCRIPTION OF DRAWINGS

FIG. 1 is a configuration diagram of a vehicle system including an automated driving control unit.

FIG. 2 is a diagram showing how the relative position and attitude of an own vehicle M with respect to a traveling lane L1 are recognized by an own vehicle position recognizer 122.

FIG. 3 is a diagram showing how a target trajectory is generated on the basis of a recommended lane.

FIG. 4 is another diagram showing how a target trajectory is generated on the basis of a recommended lane.

FIG. 5 is a diagram for explaining an example of control for returning to the original lane after lane change.

FIG. 6 is a diagram for explaining the example of control for returning to the original lane after lane change.

FIG. 7 is a diagram for explaining an example of control for not returning to the original lane after lane change.

FIG. 8 is a diagram for explaining the example of control for not returning to the original lane after lane change.

FIG. 9 is a diagram for explaining switching from automated driving to manual driving when the route of the own vehicle M has been recalculated.

FIG. 10 is a diagram for explaining another example of control for returning to the original lane after lane change.

FIG. 11 is a diagram for explaining another example of control for not returning to the original lane after lane change.

FIG. 12 is a flowchart showing an example of a process flow of the vehicle system 1.

FIG. 13 is a diagram showing a modification of the embodiment.

### DESCRIPTION OF EMBODIMENTS

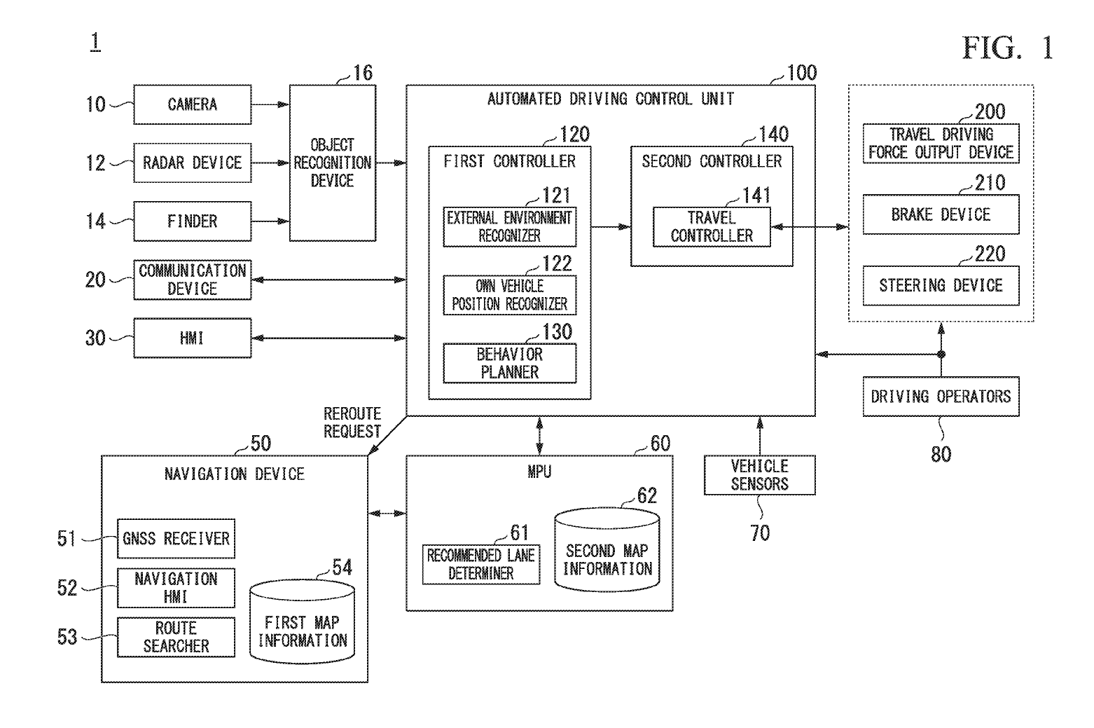

Hereinafter, embodiments of a vehicle control system, a vehicle control method, and a storage medium of the present invention will be described with reference to the drawings. FIG. 1 is a configuration diagram of a vehicle system 1 including an automated driving control unit 100. A vehicle in which the vehicle system 1 is mounted is, for example, a vehicle such as a two-wheeled vehicle, a three-wheeled vehicle, or a four-wheeled vehicle, and a driving source thereof is an internal combustion engine such as a diesel engine or a gasoline engine, an electric motor, or a combination thereof. The electric motor operates using electric power generated by a generator connected to the internal combustion engine or using discharge power of a secondary battery or a fuel cell.

The vehicle system 1 includes, for example, a camera 10, a radar device 12, a finder 14, an object recognition device 16, a communication device 20, a human machine interface (HMI) 30, a navigation device 50, a micro-processing unit (MPU) 60, vehicle sensors 70, driving operators 80, an automated driving control unit 100, a travel driving force output device 200, a brake device 210, and a steering device 220. These devices or apparatuses are connected to each other by a multiplex communication line or a serial communication line such as a controller area network (CAN) communication line, a wireless communication network, or the like. The components shown in FIG. 1 are merely an example and some of the components may be omitted or other components may be added.

The camera 10 is, for example, a digital camera using a solid-state imaging device such as a charge coupled device (CCD) or a complementary metal oxide semiconductor (CMOS). One or a plurality of cameras 10 are attached to the vehicle in which the vehicle system 1 is mounted (hereinafter referred to as an own vehicle M) at arbitrary locations. For imaging the area in front of the vehicle, a camera 10 is attached to an upper portion of a front windshield, a rear surface of a rearview mirror, or the like. For example, the camera 10 repeats imaging of the surroundings of the own vehicle M at regular intervals. The camera 10 may also be a stereo camera.

The radar device 12 radiates radio waves such as millimeter waves around the own vehicle M and detects radio waves reflected by an object (reflected waves) to detect at least the position (distance and orientation) of the object. One or a plurality of radar devices 12 may be attached to the own vehicle M at arbitrary locations. The radar device 12 may detect the position and speed of an object using a frequency modulated continuous wave (FM-CW) method.

The finder 14 is a light detection and ranging or laser imaging detection and ranging (LIDAR) finder which measures scattered light from an object in response to illuminated light to detect the distance to the object. One or a plurality of finders 14 may be attached to the own vehicle M at arbitrary locations.

The object recognition device 16 performs a sensor fusion process on results of detection by some or all of the camera 10, the radar device 12, and the finder 14 to recognize the position, type, speed, or the like of the object. The object recognition device 16 outputs the recognition result to the automated driving control unit 100.

For example, the communication device 20 communicates with other vehicles near the own vehicle M using a cellular network, a Wi-Fi network, Bluetooth (registered trademark), dedicated short range communication (DSRC) or the like or communicates with various server devices via wireless base stations such as VICSs (registered trademark).

The HMI 30 presents various types of information to an occupant in the own vehicle M and receives an input operation from the occupant. The HMI 30 includes various display devices, speakers, buzzers, touch panels, switches, keys, or the like. An operation unit such as a touch panel, a switch, or a key on the HMI 30 receives an operation to switch the driving mode of the own vehicle M from the manual driving mode to the automated driving mode. Further, the HMI 30 receives an operation for automatically switching the traveling lane of the own vehicle M from the current traveling lane of the own vehicle M to an adjacent lane. This operation can also be described as an operation indicating auto lane change (ALC). The HMI 30 can receive an operation indicating ALC both while the manual driving mode is in operation or while the automated driving mode is in operation. The vehicle system 1 may receive an operation of a turn signal lever included in the driving operators 80 as the operation indicating ALC.

The navigation device 50 includes, for example, a global navigation satellite system (GNSS) receiver 51, a navigation HMI 52, and a route searcher 53 and holds first map information 54 in a storage device such as a hard disk drive (HDD) or a flash memory. The GNSS receiver 51 specifies the position of the own vehicle M on the basis of signals received from GNSS satellites. The position of the own vehicle M may also be specified or supplemented by an inertial navigation system (INS) using the output of the vehicle sensors 70.

The navigation HMI 52 includes a display device, a speaker, a touch panel, a switch, a key, or the like. The navigation HMI 52 may be partly or wholly shared with the HMI 30 described above. The navigation HMI 52 receives information such as a destination on the basis of the occupant's operation.

For example, the route searcher 53 determines a route from the position of the own vehicle M specified by the GNSS receiver 51 (or an arbitrary input position) to a destination input by the occupant using the navigation HMI 52 by referring to the first map information 54. The route searcher 53 recalculates the route when the current position of the own vehicle M is separated from the found route by a predetermined distance or more. The route determined by the route searcher 53 is output to the MPU 60. The navigation device 50 may also perform route guidance using the navigation HMI 52 on the basis of the route determined by the route searcher 53.

The first map information 54 is, for example, information representing shapes of roads by links indicating roads and nodes connected by the links. The first map information 54 may include curvatures of roads, point of interest (POI) information, or the like.

The navigation device 50 may be realized, for example, by a function of a terminal device such as a smartphone or a tablet possessed by the user. The navigation device 50 may also transmit the current position and the destination to a navigation server via the communication device 20 and acquire a route returned from the navigation server.

The MPU 60 functions, for example, as a recommended lane determiner 61 and holds the second map information 62 in a storage device such as an HDD or a flash memory. The recommended lane determiner 61 divides the route provided from the navigation device 50 into a plurality of blocks (for example, into blocks each 100 meters long in the direction in which the vehicle travels) and determines a target lane for each block by referring to the second map information 62. The recommended lane determiner 61 determines the number of the lane from the left in which to travel. When there is a branch point, a merge point, or the like on the route, the recommended lane determiner 61 determines a recommended lane such that the own vehicle M can travel on a reasonable travel route for proceeding to the branch destination.

The second map information 62 is map information with higher accuracy than the first map information 54 in the navigation device 50. The second map information 62 includes, for example, information of the centers of lanes or information of the boundaries of lanes. The second map information 62 may also include road information, traffic regulation information, address information (addresses/postal codes), facility information, telephone number information, or the like. The road information includes information indicating the types of roads such as expressways, toll roads, national roads, or prefectural roads or information such as the number of lanes of each road, the widths of lanes, the gradients of roads, the positions of roads (three-dimensional coordinates including longitude, latitude and height), the curvatures of curves of lanes, the positions of merge or branch points of lanes, signs installed on roads, or the like. The second map information 62 may be updated as needed by accessing another device using the communication device 20.

The vehicle sensors 70 include, for example, a vehicle speed sensor that detects the speed of the own vehicle M, an acceleration sensor that detects the acceleration thereof, a yaw rate sensor that detects an angular speed thereof about the vertical axis, an orientation sensor that detects the orientation of the own vehicle M, or the like.

The driving operators 80 include, for example, an accelerator pedal, a brake pedal, a shift lever, a steering wheel, a turn signal lever, and other operators. Sensors for detecting the amounts of operation or the presence or absence of operation are attached to the driving operators 80 and detection results thereof are output to either or both of the automated driving control unit 100 or the travel driving force output, brake, and steering devices 200, 210, and 220.

The automated driving control unit 100 includes, for example, a first controller 120 and a second controller 140. Each of the first controller 120 and the second controller 140 is realized by a processor such as a central processing unit (CPU) executing a program (software). Some or all of the functional units of the first controller 120 and the second controller 140 which will be described below may be realized by hardware such as a large scale integration (LSI), an application specific integrated circuit (ASIC), or a field-programmable gate array (FPGA) or may be realized by hardware and software in cooperation.

The first controller 120 includes, for example, an external environment recognizer 121, an own vehicle position recognizer 122, and a behavior planner 130.

The external environment recognizer 121 recognizes states such as the presence or absence of an adjacent lane, the position of an adjacent lane, and the position, speed and acceleration of a nearby vehicle on the basis of information that is input from the camera 10, the radar device 12, and the finder 14 via the object recognition device 16. The position of the nearby vehicle may be represented by a representative point such as a center of gravity or a corner of the nearby vehicle or may be represented by a region expressed by a contour of the nearby vehicle. The “states” of the nearby vehicle may include an acceleration or jerk of the nearby vehicle or a “behavior state” (for example, whether or not the nearby vehicle is changing or is going to change lanes). The external environment recognizer 121 may also recognize the positions of guardrails or utility poles, parked vehicles, pedestrians, and other objects in addition to nearby vehicles.

The own vehicle position recognizer 122 recognizes, for example, a (traveling) lane in which the own vehicle M is traveling and the relative position and attitude of the own vehicle M with respect to the traveling lane. The own vehicle position recognizer 122 recognizes the traveling lane, for example, by comparing a pattern of road lane lines (for example, an arrangement of solid and broken lines) obtained from the second map information 62 with a pattern of road lane lines near the own vehicle M recognized from an image captured by the camera 10. This recognition may be performed taking into consideration a position of the own vehicle M acquired from the navigation device 50 or a result of processing by the INS.

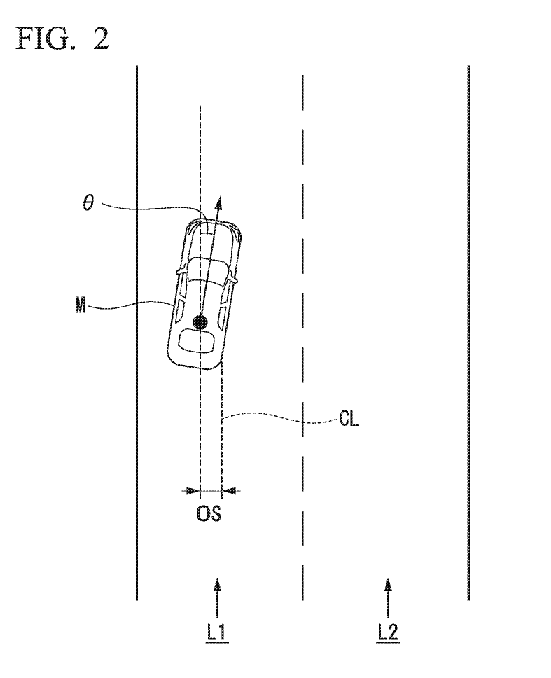

The own vehicle position recognizer 122 recognizes, for example, the position or attitude of the own vehicle M with respect to the traveling lane. FIG. 2 is a diagram showing how the relative position and attitude of the own vehicle M with respect to the traveling lane L1 are recognized by the own vehicle position recognizer 122. For example, the own vehicle position recognizer 122 recognizes both a deviation OS from a traveling lane center CL of a reference point (for example, the center of gravity) of the own vehicle M and an angle θ formed by the travel direction of the own vehicle M relative to an extension line of the traveling lane center CL as the relative position and attitude of the own vehicle M with respect to the traveling lane L1. Alternatively, the own vehicle position recognizer 122 may recognize the position of the reference point of the own vehicle M with respect to one of the sides of the traveling lane L1 or the like as the relative position of the own vehicle M with respect to the traveling lane L1. The relative position of the own vehicle M recognized by the own vehicle position recognizer 122 is provided to the recommended lane determiner 61 and the behavior planner 130.

The behavior planner 130 determines events which are to be sequentially performed in the automated driving such that the own vehicle M travels in the recommended lane determined by the recommended lane determiner 61 and copes with situations occurring near the own vehicle M. Examples of the events include a constant-speed travel event which is an event of traveling in the same lane at a constant speed, a following travel event which is an event of following a preceding vehicle, a lane change event, a merging event, a branching event, an emergency stop event, and a handover event which is an event of terminating automated driving and switching to manual driving. During execution of these events, behaviors for avoidance may sometimes be planned on the basis of situations occurring near the own vehicle M (such as the presence of nearby vehicles and pedestrians or lane narrowing due to road construction).

The behavior planner 130 generates a target trajectory along which the own vehicle M will travel in the future. The target trajectory includes, for example, a speed element. For example, the target trajectory is generated as a set of target positions (trajectory points) to be reached at a plurality of future reference period of times which are set at intervals of a predetermined sampling time (for example, about tenths of a second). Therefore, when the interval between trajectory points is great, this means that the vehicle travels at a high speed in the section between the trajectory points.

The second controller 140 includes a travel controller 141. The travel controller 141 controls the travel driving force output device 200, the brake device 210, and the steering device 220 such that the own vehicle M passes along the target trajectory generated by the behavior planner 130 at scheduled times.

The travel driving force output device 200 outputs a travel driving force (torque) required for the vehicle to travel to driving wheels. The travel driving force output device 200 includes, for example, a combination of an internal combustion engine, an electric motor, a transmission, and the like and an ECU that controls them. The ECU controls the above constituent elements according to information input from the travel controller 141 or information input from the driving operators 80.

The brake device 210 includes, for example, a brake caliper, a cylinder that transmits hydraulic pressure to the brake caliper, an electric motor that generates hydraulic pressure in the cylinder, and a brake ECU. The brake ECU controls the electric motor according to information input from the travel controller 141 such that a brake torque corresponding to a braking operation is output to each wheel. The brake device 210 may include, as a backup, a mechanism for transferring a hydraulic pressure generated by an operation of the brake pedal included in the driving operators 80 to the cylinder via a master cylinder. The brake device 210 is not limited to that configured as described above and may be an electronically controlled hydraulic brake device that controls an actuator according to information input from the travel controller 141 and transmits the hydraulic pressure of the master cylinder to the cylinder.

The steering device 220 includes, for example, a steering ECU and an electric motor. The electric motor, for example, applies a force to a rack-and-pinion mechanism to change the direction of the steering wheel. The steering ECU drives the electric motor according to information input from the travel controller 141 or information input from the driving operators 80 to change the direction of the steering wheels.

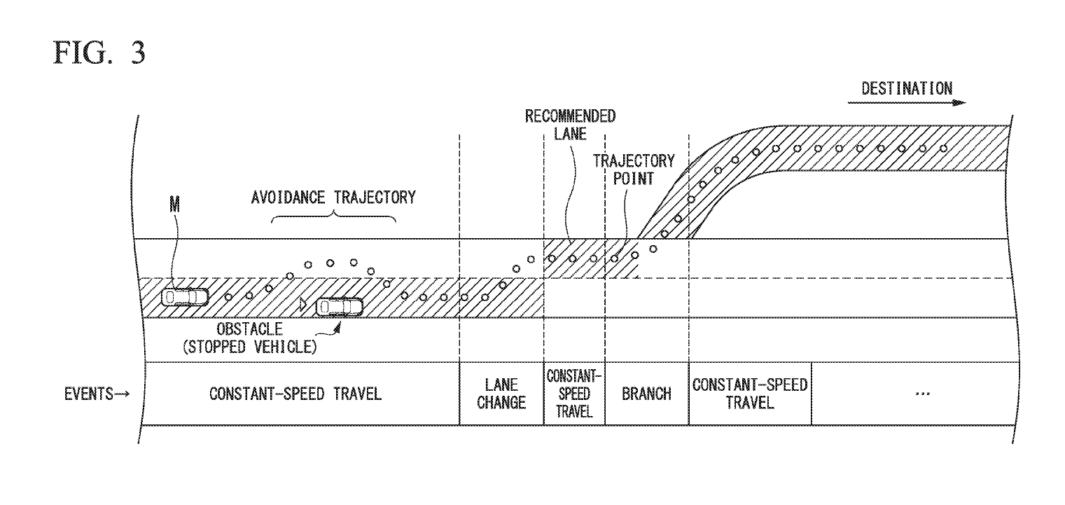

FIG. 3 is a diagram showing how a target trajectory is generated on the basis of a recommended lane. As shown, the recommended lane is set to be convenient for traveling along the route to the destination. When the own vehicle M approaches a predetermined distance (which may be determined according to the types of events) before a position for switching to the recommended lane, the behavior planner 130 activates a lane change event, a branching event, a merging event, or the like. When it becomes necessary to avoid an obstacle during execution of each event, an avoidance trajectory is generated as shown in FIG. 3. For example, the behavior planner 130 generates a plurality of candidate target trajectories and selects an optimum target trajectory at a given point in time from the viewpoint of safety and efficiency.

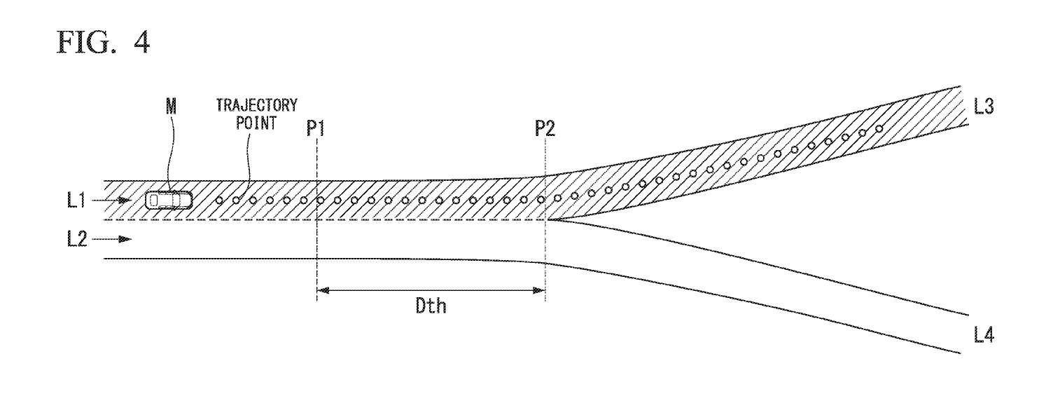

FIG. 4 is another view showing how a target trajectory is generated on the basis of a recommended lane. The behavior planner 130 generates a target trajectory for traveling from a traveling lane L1 to a left road L3 according to a route found by the navigation device 50 and a recommended lane determined by the recommended lane determiner 61. A road on which the own vehicle M is traveling branches into a left road L3 and a right road L4 at a position P2 which is a branch point. A lane L2 is adjacent to the traveling lane L1. The lane L2 is connected to the right road L4. When executing automated driving of the own vehicle M, the vehicle system 1 causes the own vehicle M to enter the left road L3 from the traveling lane L1 along the target trajectory if no operation for lane change of the own vehicle M is received. The operation for lane change of the own vehicle M is either an auto lane change operation indicating an instruction to automatically change the traveling lane of the own vehicle M or an operation to change the steering angle of the own vehicle M by moving the steering wheel or the like which is a driving operator 80.

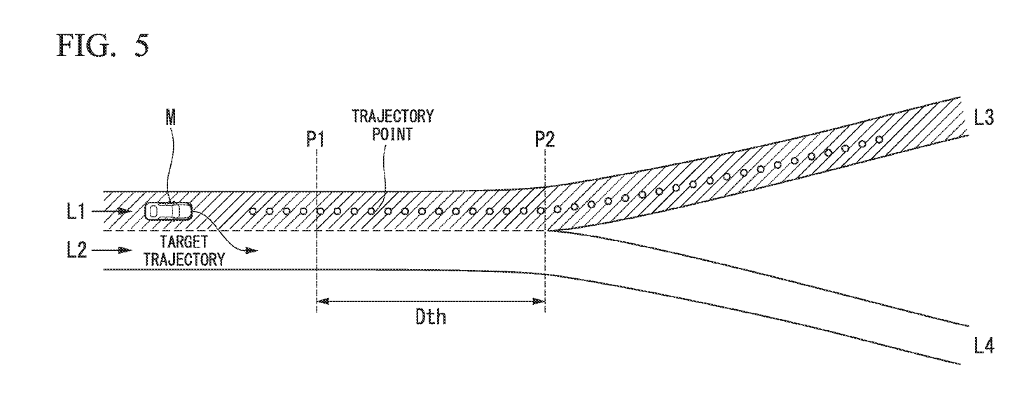

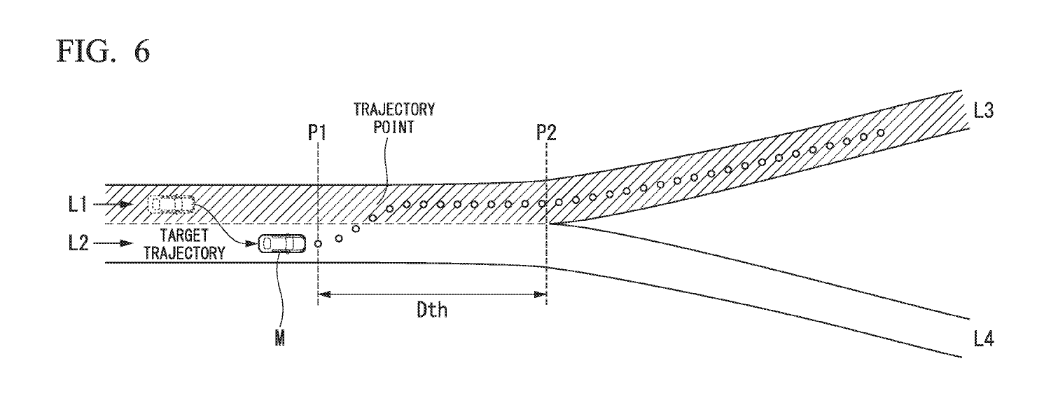

FIGS. 5 and 6 are diagrams for explaining an example of control for returning to an original lane after lane change. As shown in FIG. 5, the vehicle system 1 receives an operation for lane change of the own vehicle M from the traveling lane L1 to the lane L2 at a reference distance Dth before the position P2, the reference distance Dth being the distance from the position P2 to a position P1 which is closer to the departure point than the position P2 is. The vehicle system 1 determines that the position of the own vehicle M upon receiving the operation for lane change is behind the position P1 and does not output a rerouting request to the navigation device 50. In this case, the vehicle system 1 causes the own vehicle M to change lanes to the lane L2 and then generates a target trajectory for causing the own vehicle M to change lanes from the traveling lane L2 to the lane L1 as shown in FIG. 6. Although FIG. 6 shows an example in which lane change is completed before the position P1, it is also possible to generate a target trajectory for completing the lane change between the positions P1 and P2.

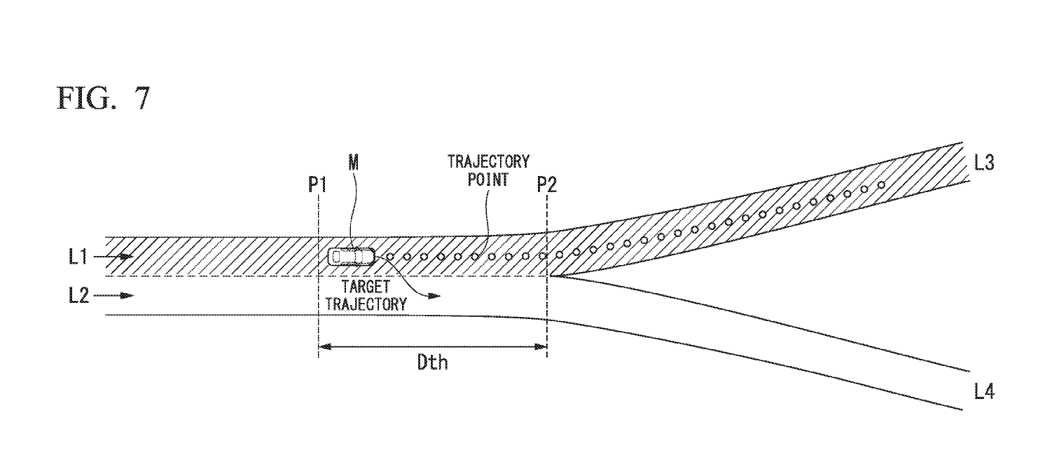

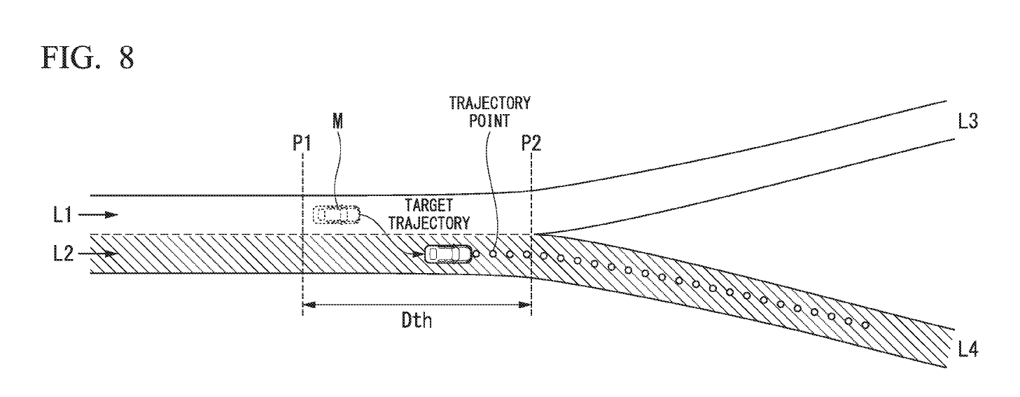

FIGS. 7 and 8 are diagrams for explaining an example of control for not returning to the original lane after lane change. As shown in FIG. 7, the vehicle system 1 receives an operation for lane change of the own vehicle M from a traveling lane L1 to a lane L2 at a position between a position P1 and a position P2. The vehicle system 1 determines that the position of the own vehicle M upon receiving the operation for lane change is between the position P1 and the position P2 and outputs a rerouting request to the navigation device 50. The rerouting request includes information requesting that the own vehicle M travel via a right road L4. The navigation device 50 recalculates a route for arriving at the destination from the current position of the own vehicle M via the right road L4.

The behavior planner 130 and the recommended lane determiner 61 acquire a route as a rerouting result from the navigation device 50 in response to the rerouting request. As shown in FIG. 8, the recommended lane determiner 61 determines that recommended lanes are the traveling lane L2 and the right road L4 on the basis of the route as the rerouting result. The behavior planner 130 generates a target trajectory for causing the own vehicle M to travel from the traveling lane L2 to the right road L4.

The vehicle system 1 determines whether or not to output a rerouting request to the navigation device 50 on the basis of the position of the own vehicle M upon receiving an operation for lane change, but the present invention is not limited to this. The vehicle system 1 may also determine whether or not to output a rerouting request to the navigation device 50 on the basis of the position at which lane change is expected to be completed. The vehicle system 1 does not output a rerouting request to the navigation device 50 when a position at which lane change is expected to be completed on the basis of the target trajectory from the current position to the lane to which the lane change is to be performed is behind the position P1 as shown in FIG. 6. On the other hand, the vehicle system 1 outputs a rerouting request to the navigation device 50 when a position at which lane change is expected to be completed on the basis of the target trajectory from the current position to the lane to which the lane change is to be performed is between the position P1 and the position P2 as shown in FIG. 8.

The vehicle system 1 can also determine whether or not to output a rerouting request to the navigation device 50 on the basis of at least one of the position of the own vehicle M upon receiving an operation for lane change or the position at which lane change is expected to be completed.

A situation in which the distance from the position of the own vehicle M upon receiving an operation for lane change or the position at which lane change is expected to be completed to the position P2 is shorter than the reference distance Dth is a situation in which it is difficult to cause the own vehicle M to travel along the route found by the navigation device 50. That is, the situation in which it is difficult to cause the own vehicle M to travel along the route found by the navigation device 50 is a situation in which it is difficult to cause the own vehicle M to change lanes again from the traveling lane L2 after the lane change to the traveling lane L1 before the lane change such that the own vehicle M is to travel on the left road L3.

The reference distance Dth may be a distance calculated on the basis of the speed of the own vehicle M. The behavior planner 130 calculates the reference distance Dth such that it increases as the speed of the own vehicle M increases.

The vehicle system 1 may also determine whether a period of time from when the lane change is expected to be completed to when the own vehicle M enters a branch road (i.e., to when it arrives at the position P2) is within a predetermined reference period of time. A situation in which the period of time from when the lane change is expected to be completed to when the own vehicle M enters the branch road is within the reference period of time is a situation in which it is difficult to cause the own vehicle M to travel along the route found by the navigation device 50. The behavior planner 130 transmits a rerouting request to the navigation device 50 when the period of time from when the lane change is expected to be completed to when the own vehicle M enters the branch road is within the reference period of time.

The behavior planner 130 may transmit a rerouting request to the navigation device 50 on the basis of either the reference distance Dth or the reference period of time. The vehicle system 1 may also transmit a rerouting request to the navigation device 50 on the basis of both the reference distance Dth and the reference period of time.

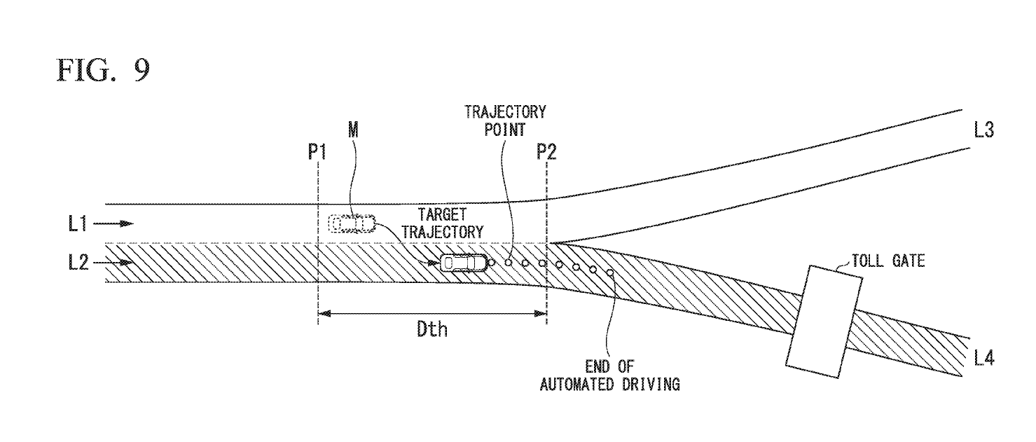

FIG. 9 is a diagram for explaining switching from automated driving to manual driving when the route of the own vehicle M has been recalculated. The automated driving control unit 100 determines whether or not to shift the driving mode of the own vehicle M from the automated driving mode to the manual driving mode on the basis of the route recalculated by the navigation device 50. For example, when there is a toll gate in the recalculated route, the automated driving control unit 100 determines to shift the driving mode from the automated driving mode to the manual driving mode. The automated driving control unit 100 provides notification of end of the automated driving mode. The automated driving control unit 100 provides notification of end of the automated driving mode, for example, by driving the speaker of the HMI 30 or the navigation HMI 52 of the navigation device 50. The timing of providing notification may be immediately before arrival at the toll gate. However, the present invention is not limited to this and the notification may be provided immediately after it is determined to shift from the automated driving mode to the manual driving mode.

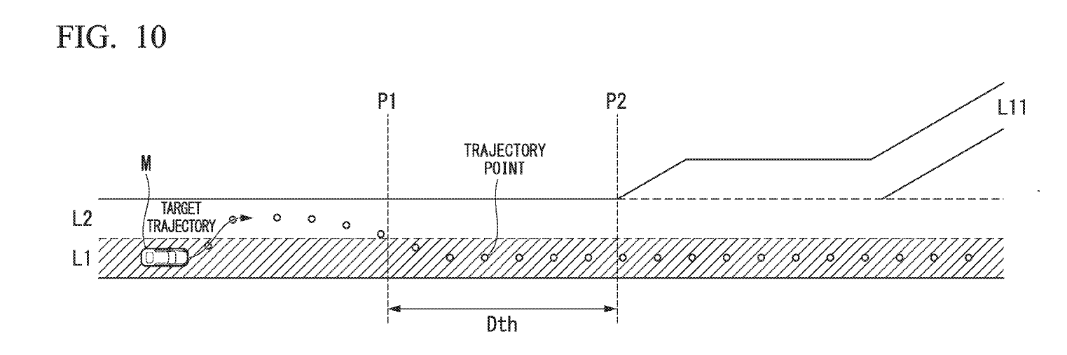

FIG. 10 is a diagram for explaining another example of control for returning to the original lane after lane change. The vehicle system 1 does not transmit a rerouting request to the navigation device 50 if an operation for lane change of the own vehicle M from a traveling lane L1 to a lane L2 is received before a position P1 which is closer to the departure point than the position P2 is. The vehicle system 1 generates a target trajectory for causing the own vehicle M to change lanes to the lane L2 and then to change lanes from the traveling lane L2 to the lane L1.

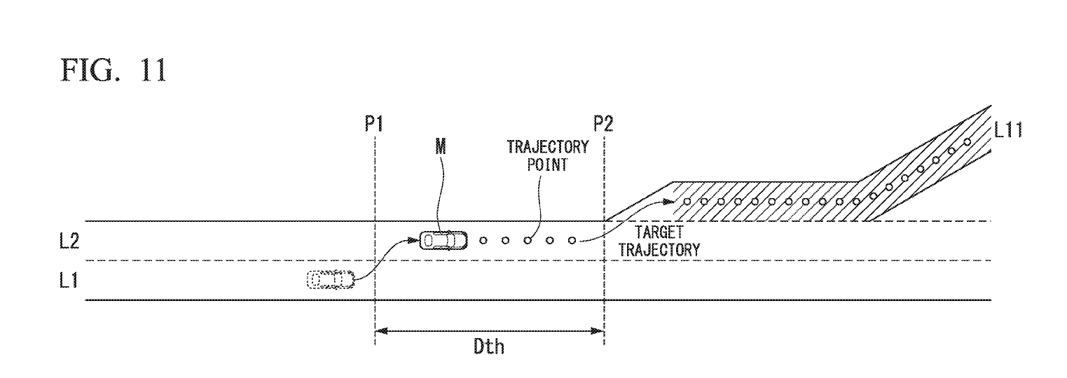

FIG. 11 is a diagram for explaining another example of control for not returning to the original lane after lane change. The vehicle system 1 transmits a rerouting request to the navigation device 50 if an operation for lane change from a lane L1 to a branch lane L11 is received additionally after the own vehicle M completes lane change to a lane L2 in response to receiving an operation for lane change from the lane L1 to the lane L2. Thus, the navigation device 50 recalculates the route.

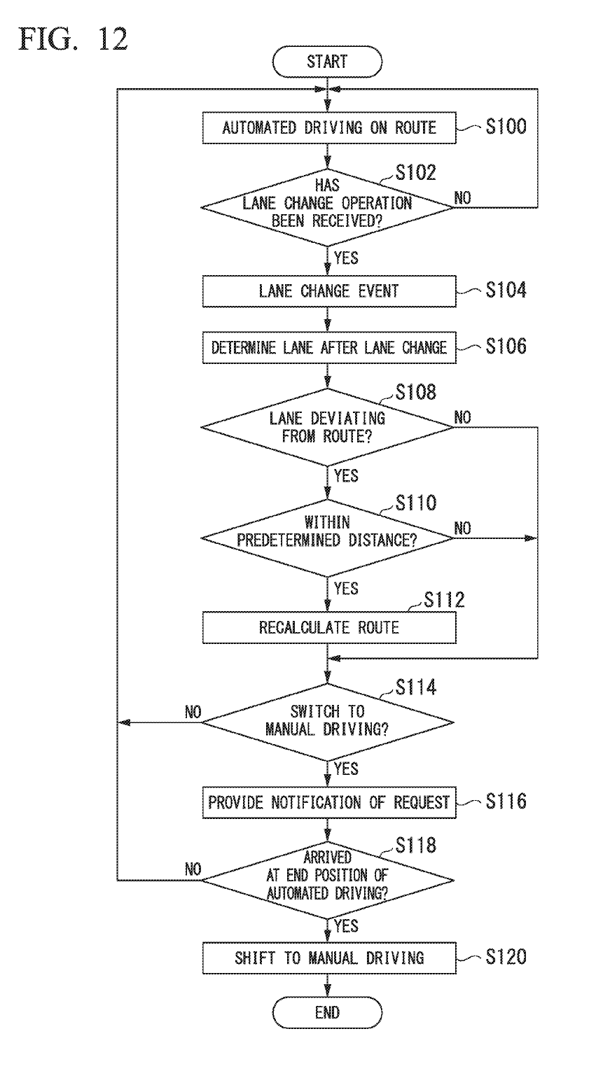

A process flow of recalculating a route through the navigation device 50 and continuing automated driving or switching from automated driving to manual driving as described above will now be described. FIG. 12 is a flowchart showing an example of the process flow of the vehicle system 1.

First, the automated driving control unit 100 causes the own vehicle M to travel in the automated driving mode along a route found by the navigation device 50 (step S100). The automated driving control unit 100 determines whether or not an operation for lane change of the own vehicle M has been received through the HMI 30 (step S102). The automated driving control unit 100 continues the automated driving mode when no operation for lane change of the own vehicle M has been received. When an operation for lane change of the own vehicle M has been received, the automated driving control unit 100 determines that a lane change event has occurred (step S104). The automated driving control unit 100 changes the target trajectory to change the traveling lane of the own vehicle M in the lane change event.

The automated driving control unit 100 determines the lane after lane change on the basis of the operation for lane change of the own vehicle M (step S106). The automated driving control unit 100 determines whether or not the determined lane after lane change is a lane deviating from the route found by the navigation device 50 (step S108). When the lane after lane change is a lane deviating from the route found by the navigation device 50, the automated driving control unit 100 determines whether or not a distance from the position of the own vehicle M when the operation for lane change of the own vehicle M is received to the position P2 is within a predetermined distance (step S110). When the distance from the position of the own vehicle M when the operation for lane change of the own vehicle M is received to the position P2 is within the predetermined distance, the automated driving control unit 100 causes the navigation device 50 to recalculate the route (step S112) and advances the process to step S114. When the lane after lane change is not a lane deviating from the route found by the navigation device 50 or when the distance from the position of the own vehicle M when the operation for lane change of the own vehicle M is received to the position P2 is not within the predetermined distance, the automated driving control unit 100 advances the process to step S114.

Instead of the above processing, the automated driving control unit 100 may advance the process to step S112 upon determining in step S110 that the distance between the position of the own vehicle M when an operation indicating an instruction to automatically change the traveling lane of the own vehicle M is received and a position at which the own vehicle M enters a branch road is within a distance calculated on the basis of the speed of the own vehicle M. The automated driving control unit 100 may also advance the process to step S112 when a period of time from when an operation indicating an instruction to automatically change the traveling lane of the own vehicle M is received to when the own vehicle M enters the branch road is within a predetermined period of time or a period of time calculated on the basis of the speed of the own vehicle M. Further, the automated driving control unit 100 may advance the process to step S112 when the distance between a position at which the lane change of the own vehicle M is expected to be completed and the position at which the own vehicle M enters the branch road is within a predetermined distance or a distance calculated on the basis of the speed of the own vehicle M. Furthermore, the automated driving control unit 100 may do the same when a period of time from when the lane change of the own vehicle M is expected to be completed to when the own vehicle M enters the branch road is within a predetermined period of time or a period of time calculated on the basis of the speed of the own vehicle M.

Next, the automated driving control unit 100 determines whether or not to switch from the automated driving mode to the manual driving mode when the own vehicle M is caused to travel along the recalculated route (step S114). The automated driving control unit 100 determines to switch from the automated driving mode to the manual driving mode, for example, when the distance from the position of the own vehicle M to a toll gate on the recalculated route is equal to or less than a predetermined distance. The automated driving control unit 100 may also determine to switch from the automated driving mode to the manual driving mode when the distance to a predetermined facility such as a junction or an exit of a toll road, not limited to the toll gate, is equal to or less than a predetermined distance.

The automated driving control unit 100 returns the process to step S100 when not switching from the automated driving mode to the manual driving mode. Thus, the automated driving control unit 100 continues automated driving. When switching from the automated driving mode to the manual driving mode, the automated driving control unit 100 provides notification of a request that the own vehicle M be manually driven (step S116).

Next, the automated driving control unit 100 determines whether or not the position of the own vehicle M is that of having arrived at an end position of the automated driving mode (step S118). The automated driving control unit 100 stands by when the position of the own vehicle M is not that of having arrived at the end position of the automated driving mode. When the position of the own vehicle M is that of having arrived at the end position of the automated driving mode, the automated driving control unit 100 shifts to the manual driving mode (step S120).

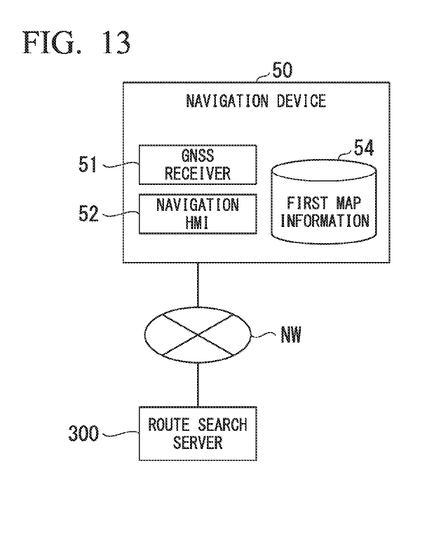

FIG. 13 is a diagram showing a modification of the embodiment. In the above embodiment, the vehicle system 1 includes the route searcher 53 as a function of searching for a route. However, the function of searching for a route may also be included in a route search server 300 that is connected to the vehicle system 1 via a network NW. The automated driving control unit 100 communicates with the route search server 300, for example, using the communication device 20. When the route search server 300 receives a destination from the vehicle system 1, the route search server 300 searches for a route for travel from the position of the own vehicle M to the destination and transmits route information as a search result to the vehicle system 1. Upon receiving a rerouting request from the vehicle system 1, the route search server 300 recalculates the route and transmits a rerouting result to the vehicle system 1.

According to the vehicle system 1 described above, when the occupant of the own vehicle M has performed an operation on the HMI 30 to cause the own vehicle M to travel in a direction out of the route at a branch road, the navigation device 50 is caused to recalculate the route on the basis of a predetermined condition. Therefore, when the traveling route of the own vehicle M deviates from a route, along which automated driving is being executed, with the intention of the occupant, it is possible to appropriately switch the route.

The navigation device 50 recalculates the route on the basis of the position of the own vehicle M when the own vehicle M tries to travel on a branch road, deviating from the route. On the other hand, according to the vehicle system 1, even when the own vehicle M is traveling on the route, a rerouting request is transmitted to the navigation device 50, assuming that the route already found has been canceled, if a road connected to a lane to which lane change is to be performed from the recommended lane deviates from the route. Thus, even when the own vehicle M is traveling on the route, the navigation device 50 can appropriately recalculate the route on the basis of the occupant's operation.

Further, according to the vehicle system 1, it is determined whether or not it is possible to continue automated driving when traveling along the recalculated route. Thereby, according to the vehicle system 1, it is possible to continue automated driving toward the destination, for example, even when traveling on a road branching from the route found by the navigation device 50. Furthermore, according to the vehicle system 1, for example, in the case of traveling on a road branching from the route found by the navigation device 50, it is possible to terminate automated driving and switch to manual driving, for example, when it is necessary to enter a general road from a toll road.

In addition, according to the vehicle system 1, when the occupant has performed an operation for executing lane change with the intention to switch from the route found by the navigation device 50 to another route, it is possible to prevent lane change again to return to the route found by the navigation device 50 if it is difficult to cause the own vehicle M to travel along the route found by the navigation device 50 (which is an example of the predetermined condition).

Further, according to the vehicle system 1, when the occupant has performed an operation for executing lane change with the intention to switch from the route found by the navigation device 50 to another route, it is possible to prevent lane change again to return to the route found by the navigation device 50 if the distance between the position of the own vehicle M when an operation indicating an instruction to automatically change the traveling lane of the own vehicle M is received or a position at which the lane change of the own vehicle M is expected to be completed and a position at which the own vehicle M enters a branch road is within a predetermined distance or a distance calculated on the basis of the speed of the own vehicle M (which is an example of the predetermined condition).

Furthermore, according to the vehicle system 1, when the occupant has performed an operation for executing lane change with the intention to switch from the route found by the navigation device 50 to another route, it is possible to prevent lane change again to return to the route found by the navigation device 50 if a period of time from when an operation indicating an instruction to automatically change the traveling lane of the own vehicle M is received or from when the lane change of the own vehicle M is expected to be completed to when the own vehicle M enters the branch road is within a predetermined period of time or a period of time calculated on the basis of the speed of the own vehicle M (which is an example of the predetermined condition).

In addition, according to the vehicle system 1, it is possible to determine whether or not to shift from the automated driving mode to the manual drive mode on the basis of the recalculated route and to continue the execution of automated driving on the basis of the determination result. Thereby, according to the vehicle system 1, it is possible to continue automated driving when the vehicle can arrive at the destination even if the route is changed. Moreover, according to the vehicle system 1, when the route has been changed, it is possible to terminate automated driving, for example, if it is necessary to enter a general road from the toll road.

Further, according to the vehicle system 1, when the driving mode of the own vehicle M is to be shifted from the automated driving mode to the manual driving mode on the basis of the recalculated route, notification of this fact is provided. Therefore, for example, when the own vehicle M deviates from the route found by the navigation device 50 due to the occupant's operation, it is possible to shift from automated driving to manual driving while the occupant is made aware of the shift to manual driving.

Although the modes for carrying out the present invention have been described above by way of embodiments, the present invention is not limited to these embodiments at all and various modifications and substitutions can be made without departing from the gist of the present invention.

### REFERENCE SIGNS LIST

1 Vehicle system
30 HMI
50 Navigation device
52 Navigation HMI
53 Route searcher
54 First map information
60 MPU
61 Recommended lane determiner
70 Vehicle sensor
100 Automated driving control unit
120 First controller
130 Behavior planner
140 Second controller

What is claim is:

1. A vehicle control system comprising:
a searcher configured to search for a route along which a vehicle is to travel to a destination;
an automated driving controller configured to execute automated driving of causing the vehicle to automatically travel along the route found by the searcher;
a receiving unit configured to receive an operation performed by an occupant of the vehicle; and
a search controller configured to cause the searcher to recalculate the route on the basis of a predetermined condition when the occupant has performed an operation on the receiving unit to cause the vehicle to travel in a direction out of the route at a branch road.

2. The vehicle control system according to claim 1,
wherein the receiving unit is configured to receive an operation indicating an instruction to automatically change a traveling lane of the vehicle.

3. The vehicle control system according to claim 1, wherein the receiving unit is configured to receive an operation to change a steering angle of the vehicle.

4. The vehicle control system according to claim 1, wherein the predetermined condition is that it is difficult to cause the vehicle to travel along the route found by the searcher.

5. The vehicle control system according to claim 2, wherein the predetermined condition is that a distance between a position of the vehicle when the reception unit receives an operation indicating an instruction to automatically change the traveling lane of the vehicle and a position at which the vehicle enters the branch road is within a predetermined distance or a distance calculated on the basis of a speed of the vehicle.

6. The vehicle control system according to claim 2, wherein the predetermined condition is that a period of time from when the reception unit receives an operation indicating an instruction to automatically change the traveling lane of the vehicle to when the vehicle enters the branch road is within a predetermined period of time or a period of time calculated on the basis of a speed of the vehicle.

7. The vehicle control system according to claim 2, wherein the predetermined condition is that a distance between a position at which lane change of the vehicle according to the operation received by the reception unit is expected to be completed and a position at which the vehicle enters the branch road is within a predetermined distance or a distance calculated on the basis of a speed of the vehicle.

8. The vehicle control system according to claim 2, wherein the predetermined condition is that a period of time from when lane change of the vehicle according to the operation received by the reception unit is expected to be completed to when the vehicle enters the branch road is within a predetermined period of time or a period of time calculated on the basis of a speed of the vehicle.

9. The vehicle control system according to claim 1, further comprising a determiner configured to determine whether or not to shift the driving mode of the vehicle from an automated driving mode to a manual driving mode on the basis of the route recalculated by the searcher,
wherein the automated driving controller is configured to continue or terminate execution of the automated driving on the basis of a result of the determination of the determiner.

10. The vehicle control system according to claim 9, further comprising a notifying unit configured to provide notification of shift to manual driving when the automated driving controller terminates execution of the automated driving.

11. A vehicle control method using a computer comprising:
searching for a route along which a vehicle is to travel to a destination;
executing automated driving of causing the vehicle to automatically travel along the found route; and
recalculating the route on the basis of a predetermined condition when an occupant of the vehicle has performed an operation to cause the vehicle to travel in a direction out of the route at a branch road.

12. A computer-readable non-transitory storage medium storing a vehicle control program causing a computer to:
search for a route along which a vehicle is to travel to a destination;
execute automated driving of causing the vehicle to automatically travel along the found route; and
recalculate the route on the basis of a predetermined condition when an occupant of the vehicle has performed an operation to cause the vehicle to travel in a direction out of the route at a branch road.
